(19) United States
(12) Patent Application Publication
(10) Pub. No.: US 2014/0162715 A1
(43) Pub. Date: Jun. 12, 2014

(54) CHANNEL INFORMATION PROVIDING METHOD, CHANNEL INFORMATION PROVIDING DATABASE SERVER, AND CHANNEL INFORMATION PROVIDING SYSTEM

(71) Applicant: Electronics and Telecommunications Research Institute, Daejeon (KR)

(72) Inventors: Jin Suk PAK, Daejeon (KR); Sung Jin YOO, Daejeon (KR); Sang Won KIM, Daejeon (KR); Jung Sun UM, Daejeon (KR); Byung Jang JEONG, Daejeon (KR)

(21) Appl. No.: 13/938,935

(22) Filed: Jul. 10, 2013

(30) Foreign Application Priority Data
Dec. 11, 2012 (KR) 10-2012-0143775

(51) Int. Cl. H04W 72/10

(52) U.S. Cl. CPC H04W 72/10
USPC 455/512

(57) ABSTRACT

The present invention provides a channel information providing method, a channel information providing database server, and a channel information providing system which receive channel quality information from a cognitive radio terminal which receives channel information based on position information and efficiently use channels using the received information. A channel information providing method which uses a database server to provide channel information to a cognitive radio terminal based on position information includes providing channel information to at least one cognitive radio terminal; receiving collected information regarding a quality of the channel from the at least one cognitive radio terminal; and determining to update the channel information provided in the providing using the information received in the receiving.

### CROSS-REFERENCE TO RELATED APPLICATIONS

This application claims priority to and the benefit of Korean Patent Application No. 10-2012-0143775 filed in the Korean Intellectual Property Office on Dec. 11, 2012, the entire contents of which are incorporated herein by reference.

### TECHNICAL FIELD

The present invention relates to a channel information providing method, a channel information providing database server, and a channel information providing system. More specifically, the present invention relates to a channel information providing method, a channel information providing database server, and a channel information providing system which can receive channel quality information from a cognitive radio terminal which is supplied with channel information based on position information and efficiently use channels using the received information.

### BACKGROUND ART

A cognitive radio network system which has received attention in recent years monitors a frequency resource, which is not used by a primary user, in real time to transmit and receive data using the frequency resource of the primary user.

In the cognitive radio network system, a communication devices need to recognize status information of a channel or a band, the communication devices which operate at an open spectrum band where shares a band. In the cognitive radio network system which recognizes a channel condition to select an available band or channel to be operated, there are mainly two methods of recognizing and obtaining the channel condition information.

One of the two methods is a method of sensing an operable band or channel to directly obtain usage information. The other method is a method of transmitting position information of a cognitive radio terminal which will use the channel to a database server to obtain available channel or frequency information from the database server.

The method that uses a sensing function immediately obtains the current channel condition so that information in accordance with change in the channel condition is obtained in accordance with a sensing cycle to instantly respond to the change in the channel condition.

In the meantime, in the method which uses the database server, the cognitive radio terminal which will use the cognitive radio technique receives the channel information from the database server to determine a channel to be used so that channel information which is available for a specific time based on the transmitting position information is obtained. Therefore, the method may use only previous information before requesting new information from the database server to obtain the new information.

That is, the method which uses the database server cannot promptly reflect the information of the channel and the channel quality which vary depending on the movement of the position of the cognitive radio terminal or the change of surrounding environment of the cognitive radio terminal and cannot promptly respond thereto.

The method which uses the database server cannot obtain the status change information of an allocated channel after transmitting information on an available channel based on the position information to allocate the channel.

### SUMMARY OF THE INVENTION

The present invention has been made in an effort to provide a channel information providing method, a channel information providing database server, and a channel information providing system which receive channel quality information from a cognitive radio terminal which is supplied with channel information based on position information and efficiently use the channel using the received information.

An exemplary embodiment of the present invention provides a channel information providing method which uses a database server to provide channel information to a cognitive radio terminal based on position information, the method including: providing channel information to at least one cognitive radio terminal; receiving collected information regarding a quality of the channel from the at least one cognitive radio terminal; and determining to update the channel information provided in the providing using the information received in the receiving.

The providing may provide the updated channel information to at least one of a cognitive radio terminal which provides the information collected for the channel quality or other cognitive radio terminal which requests to provide the channel information.

The information received in the receiving may be information which determines a priority of the channel in the database server.

The information received in the receiving may include at least one of a signal to interference plus noise ratio (SINR), a noise energy level, a packet error rate (PER), a data rate, a channel utilization rate, and sensing signal information.

The determining may divide a channel in which there is no signal as a first priority group, a channel in which a signal is provided but coexists as a second priority group, and a channel which cannot be used as a third priority group using the received information on the quality of the channel, determine the priority of the channel in the first priority group using the noise energy level and the packet error rate, and determine the priority of the channel in the second priority group using the signal to interference plus noise ratio, the noise energy level, the data rate, the channel utilization rate, and the packet error rate.

The receiving periodically may receive the information collected for the quality of the channel from the cognitive radio terminal which receives channel information, and if the information collected for the quality for the channel is not periodically received, transmit a message checking the operation to the cognitive radio terminal from which the information is not received.

The updated channel information in the determining may include information which determines the priority of the channel by reflecting the information on the channel quality received in the receiving.

Another exemplary embodiment of the present invention provides a database server which provides channel information to a cognitive radio terminal based on position information, the database server including: an information providing unit which provides channel information to at least one cognitive radio terminal; a receiving unit which receives information collected for a quality of the channel from the at least one cognitive radio terminal; and a determining unit which uses the received collected information to update the provided channel information.

The information providing unit may provide the updated channel information to at least one of a cognitive radio terminal which provides the information collected for the channel quality or other cognitive radio terminal which requests to provide the channel information.

The information received in the receiving unit may be information which determines a priority of the channel.

The information received in the receiving unit may include at least one of a signal to interference plus noise ratio (SINR), a noise energy level, a packet error rate (PER), a data rate, a channel utilization rate, and a sensing signal.

The determining unit may divide a channel in which there is no signal as a first priority group, a channel in which a signal is provided but coexists as a second priority group, and a channel which cannot be used as a third priority group using the received information on the quality of the channel, determine the priority of the channel in the first priority group using the noise energy level and the packet error rate, and determine the priority of the channel in the second priority group using the signal to interference plus noise ratio, the noise energy level, the data rate, the channel utilization rate, and the packet error rate.

The receiving unit may periodically receive the information collected for the quality of the channel from the cognitive radio terminal which receives channel information, and if the information collected for the quality for the channel is not periodically received, transmit a message checking the operation to the cognitive radio terminal from which the information is not received.

The updated channel information in the determining unit may include information which determines the priority of the channel by reflecting the information on the channel quality received in the receiving unit.

Yet another exemplary embodiment of the present invention provides a channel information providing system which uses a database server to provide channel information to a cognitive radio terminal based on position information, the system including: a channel information providing database device including: an information providing unit which provides channel information to at least one cognitive radio terminal; a receiving unit which receives information collected for a quality of the channel from the at least one cognitive radio terminal; and a determining unit which uses the received information received in the receiving unit to update the channel information provided in the information providing unit; and a cognitive radio terminal which receives the provided channel information and collects and transmits information for the quality of the channel.

The information providing unit may provide the updated channel information to at least one of a cognitive radio terminal which provides the information collected for the channel quality or other cognitive radio terminal which requests to provide the channel information.

The information received in the cognitive radio terminal may include at least one of a signal to interference plus noise ratio (SINR), a noise energy level, a packet error rate (PER), a data rate, a channel utilization rate, and a sensing signal.

The updated channel information in the determining unit may include information which determines the priority of the channel by reflecting the information on the channel quality received in the receiving unit.

The determining unit may divide a channel in which there is no signal as a first priority group, a channel in which a signal is provided but coexists as a second priority group, and a channel which cannot be used as a third priority group using the received information of the quality of the channel, determine the priority of the channel in the first priority group using the noise energy level and the packet error rate, and determine the priority of the channel in the second priority group using the signal to interference plus noise ratio, the noise energy level, the data rate, the channel utilization rate, and the packet error rate.

The present invention reflects a case when a quality of a channel allocated in a cognitive radio network system using a database server varies depending on a time and a change in the environment to promptly reallocate better channel.

The present invention may efficiently allocate a channel in a cognitive radio network system which provides channel information based on position information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a channel information providing system according to an exemplary embodiment of the present invention.

FIG. 2 is a block diagram of a channel information providing database server according to an exemplary embodiment of the present invention.

FIG. 3 is a flowchart illustrating a channel information providing method according to an exemplary embodiment of the present invention.

FIG. 4 is a flowchart illustrating a channel information providing method according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the drawings. Substantially same components in the following description and the accompanying drawings may be denoted by the same reference numerals and redundant description will be omitted. In the description of the exemplary embodiment, if it is considered that specific description of related known configuration or function may unnecessarily cloud the gist of the present invention, the detailed description thereof will be omitted.

It should be understood that, when it is described that an element is coupled or connected to another element, the element may be directly coupled or directly connected to the other element or coupled or connected to the other element through a third element. In contrast, it should be understood that, when it is described that an element is directly coupled or directly connected to another element, no element is present between the element and the other element.

In this description, a singular form may include plural form if not specifically mentioned. “Comprise” and/or “comprising” of the description does not exclude the presence or addition of one or more components, steps, operations and/or elements other than a mentioned component, step, operation and/or element.

The present invention is desirably applied to a cognitive radio technology in which if a database server receives position information of a cognitive radio terminal, the database server transmits available channel information to the cognitive radio terminal.

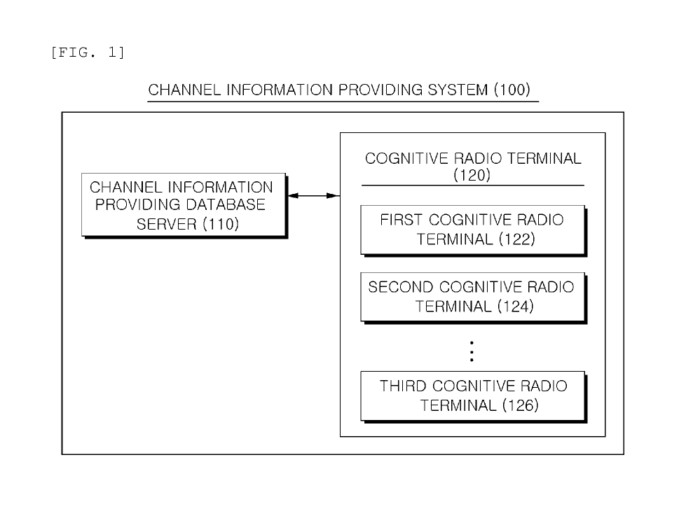

FIG. 1 is a block diagram illustrating a channel information providing system according to an exemplary embodiment of the present invention.

Referring to FIG. 1, a channel information providing system 100 according to an exemplary embodiment of the present invention includes a channel information providing database server 110 and a cognitive radio terminal 120.

The cognitive radio terminal 120 includes various terminals which are capable of performing wireless communication by a cognitive radio technology and use the position information. According to the exemplary embodiment of the present invention, at least one cognitive radio terminal 120 includes the channel information providing system 100, and desirably two or more cognitive radio terminals include the channel information providing system 100.

That is, if the cognitive radio terminal 120 includes three terminals, as illustrated in FIG. 1, for example, a first cognitive radio terminal 120, 122, a second cognitive radio terminal 120, 124, and a third cognitive radio terminal 120, 126, the channel information providing database server 110 transmits the channel information to the three terminals and receives the channel quality information. That is, if two or more cognitive radio terminals 120 are provided, the channel information providing database server 110 receives more channel quality information and transmits the channel information including a priority to the cognitive radio terminal 120 using the channel quality information.

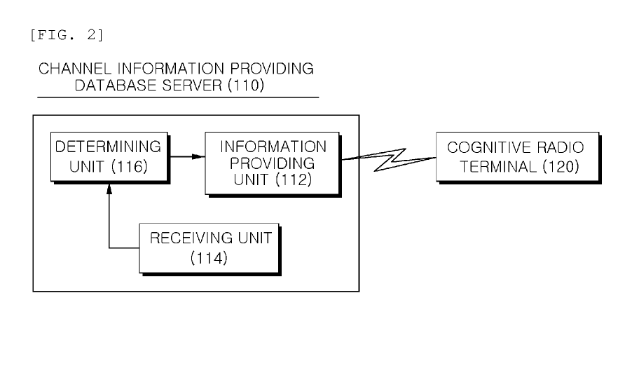

FIG. 2 is a block diagram of a channel information providing database server according to an exemplary embodiment of the present invention.

The channel information providing database server 110 will be specifically described with reference to FIG. 2. The channel information providing database server 110 includes an information providing unit 112, a receiving unit 114, and a determining unit 116.

The information providing unit 112 transmits the channel information to the cognitive radio terminal 120 which transmits position information.

The channel information providing database server 110 and the cognitive radio terminal 120 are connected through wireless communication so that the information providing unit 112 may also transmit the channel information to the cognitive radio terminal 120 through the wireless communication.

The channel information which is transmitted by the information providing unit 112 may be available channel list information including priority information. The priority information of the channel may be generated usage information which is provided before creating the available channel list information for the channel, and the specific method which is used to create such information may use a known cognitive radio technology.

If the information providing unit 112 transmits the channel information to the cognitive radio terminal 120, the cognitive radio terminal 120 receives the channel information so as to perform wireless communication using a channel having the highest priority among the available channels or a specific channel among the available channels.

While the cognitive radio terminal 120 uses the channel information provided from the information providing unit 112 to select the channel to perform the wireless communication, the channel quality, such as geographical position movement of the cognitive radio terminal 120, a change of a surrounding environment of the cognitive radio terminal 120, may be changed. The cognitive radio terminal 120 transmits the channel quality information to the channel information providing database server 110 and the receiving unit 114 receives the transmitted channel quality information.

Specifically, when the information providing unit 112 transmits the channel information to the cognitive radio terminal 120, unit time information (interval) may be included. The cognitive radio terminal 120 may transmit the channel quality information which is collected using the channel to the channel information providing database server 110 for every interval time. The channel information which is transmitted from the information providing unit 112 to the cognitive radio terminal 120 may include a maximum transmission power and an effective time of the channel information.

The channel quality information which is transmitted from the information providing unit 112 to the channel information providing database server 110 is desirably information which may be used to determine a priority of the channel in accordance with a quality of the channel in the channel information providing database server 110. Specifically, the channel quality information which is transmitted from the information providing unit 112 to the channel information providing database server 110 includes at least one of a signal to interference plus noise ratio (SINR), a packet error rate (PER), a data rate, a channel utilization rate, and sensing signal information.

The channel utilization rate may be varied depending on modulation even at the same data rate. The sensing signal information refers to signal information of other terminals which are utilized at a channel regardless of the presence of the sensing module and may include information such as a noise index of the channel, a strength of the signal, a type of the signal, or a reception power of the signal. If there is no channel signal, the SINR may use an energy level of the noise.

The channel information providing database server 110 uses the channel quality information received from the cognitive radio terminal 120 to update channel information which will be transmitted to the cognitive radio terminal 120.

Specifically, the determining unit 116 uses the signal to interference plus noise ratio (SINR), the packet error rate (PER), the data rate, the channel utilization rate, or the sensing signal information which is included in the channel quality information transmitted from the cognitive radio terminal 120 to analyze the quality of the channel to determine the priority and update the channel information.

More specifically, an example of a process of determining the channel priority and updating the channel information performed by the determining unit 116 will be described. The determining unit 116 checks whether there is channel quality information and determines whether the channel quality information is available in accordance with the sensing information in the available channel. The channel quality information which is required for this process may be the type of signal, the reception power of the signal, and the noise energy level of the channel.

The determining unit 116 determines whether the signal coexists or not or the signal needs to be protected in accordance with the type of signals. The determining unit 116 determines a channel in which no signal is present as a highest priority group (first priority group), a channel in which there is a signal which can coexist as a next priority group (second priority group), and the channel, which cannot be used, as a next priority group (third priority group). The determining unit 116 may determine a priority in each of the priority groups, again.

Specifically, if there is no signal which operates at an available channel (first priority group), the determining unit 116 uses the channel quality information and the noise energy level information to determine the priority of the channel in the highest priority group. That is, the determining unit 116 determines whether the channel is clear or has lots of noises to determine the priority of the channel. The determining unit 116 determines such that a channel has a high priority as the channel is clear.

If there is no signal which operates at the available channel, the determining unit 116 may determine a weight value of the priority through not only the channel quality information and the noise energy level information but also the PER. That is, the determining unit 116 primarily determines the priority of the channel in the group using the energy level information and then redetermines the priority by determining the weight value of the priority using the PER. Specifically, a method of determining the priority using the PER by the determining unit 116 will be described. If the transmission and reception are performed through the channel, the PER becomes the transmission and reception quality of the channel. Therefore, if the cognitive radio terminal which has used the channel immediately before moves to another channel due to the bad channel transmission/reception quality, the weight value of the priority is increased so that the priority is lowered. In contrast, even though the PER is present, but when the time has elapsed, the weight value is lowered as time goes by. If an effective time of the PER has elapsed, the weight value disappears so that the priority may be determined by the noise energy level.

The determining unit 116 may determine the priority through the SINR and the noise energy level also in the coexistable group which is a next priority group (second priority group). The determining unit 116 determines the priority through the SINR and the noise energy level and then uses the data rate and the utilization and the PER to adjust the weight value to determine the priority. That is, the determining unit 116 uses the PER to determine the maximum service amount and uses the data rate and the utilization to check a remaining available service amount other than the preoccupied amount to determine the priority.

The group which cannot be used (third priority group) cannot be used so that the determining unit 116 determines all of the group which cannot be used to have the lowest priority or allows the information indicating unserviceability to be included in the group.

If the determining unit 116 updates the channel information, the information providing unit 112 provides the updated channel information to the cognitive radio terminal 120 which requests the channel information or the cognitive radio terminal 120 which provides the channel information.

The cognitive radio terminal 120 receives the updated channel information. If there is a channel which has better quality than the currently used channel, the cognitive radio terminal 120 changes the channel into the excellent channel to be used in the wireless communication.

While the channel information providing database server 110 and the cognitive radio terminal are wirelessly connected, that is, the cognitive radio terminal uses the channel and receives the available channel information from the channel information providing database server 110, the channel information providing database server 110 and the cognitive radio terminal 120 periodically transmit and receive the information.

That is, the channel information providing database server 110 periodically provides the channel information or updated channel information to a wireless terminal. The wireless terminal may periodically provide collected channel quality information to the channel information providing database server 110.

When the wireless terminal periodically provides the collected channel quality information to the channel information providing database server 110, a period to be set may be set using the unit time information (interval) which is transmitted when the channel information is transmitted from the channel information providing database server 110. That is, the wireless terminal may transmit the collected channel quality information to the channel information providing database server 110 at every interval time.

A period T1 when the channel information providing database server 110 provides the channel information or the updated channel information to the wireless terminal may be different from a period T2 when the wireless terminal provides the collected channel quality information to the channel information providing database server 110.

Desirably, T2 is shorter than T1. This is because only when the channel quality information is provided, the determining unit 116 updates the channel information using the provided channel quality information. Therefore, T1 and T2 may be set so as to promptly respond to the change in the channel quality due to the movement of the cognitive radio terminal 120 or the change of the surrounding environment and to transmit the one-time updated channel information to the cognitive radio terminal 120 if approximately two channel quality information is provided to the channel information providing database server 110 while considering the data processing amount.

If the receiving unit 114 does not receive the channel quality information at a time set to receive the channel quality information, the information providing unit 112 transmits a message M1 which checks whether the cognitive radio terminal 120 operates to the cognitive radio terminal 120. The information providing unit 112 receives a message which is transmitted by the cognitive radio terminal 120 so as to respond to the message M1 and if the cognitive radio terminal 120 operates, transmits a message to retransmit the channel quality information to the cognitive radio terminal 120. In contrast, if the cognitive radio terminal 120 does not operate, the information providing unit may stop transmitting the channel information which is provided to the cognitive radio terminal 120 which completes the operation. Even when the cognitive radio terminal 120 does not respond to the message M1, the channel information providing database server 110 stops transmitting the channel information to the cognitive radio terminal 120 which does not respond.

If the information providing unit 112 changes the period when the channel quality information is transmitted from the cognitive radio terminal 120, when the updated channel information is transmitted to the cognitive radio terminal 120, the information providing unit 112 transmits the period information to be changed together.

The cognitive radio terminal 120 receives the channel information which is updated with the period T1, and determines the operating channel using the received and updated channel information.

The channel information providing database receives the channel quality information from two or more cognitive radio terminals 120 such as a first cognitive radio terminal 120 or 122, a second cognitive radio terminal 120 or 124, and a third cognitive radio terminal 120 or 126 of the cognitive radio terminal 120 which provides the position information and redetermines the priority of the channel using the received channel quality information so that the updated channel information may be provided to the cognitive radio terminal 120 which requests or requires the channel information. If the first cognitive radio terminal 120 or 122 and the second cognitive radio terminal 120 or 124 have a geographical position in order to coexist, the channel information including coexistence strategy may be transmitted to the first cognitive radio terminal 120 and the second cognitive radio terminal 120.

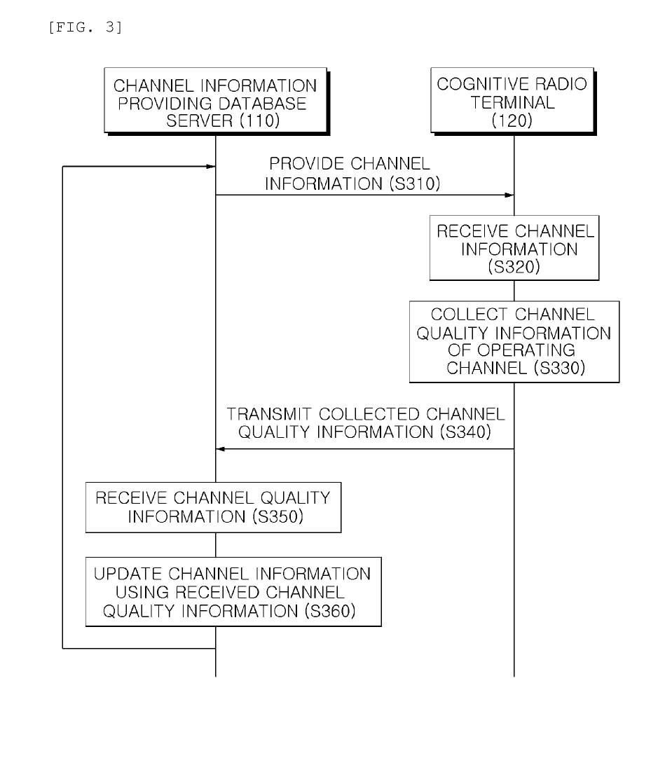

FIG. 3 is a flowchart illustrating a channel information providing method according to an exemplary embodiment of the present invention.

A channel information providing method according to an exemplary embodiment of the present invention will be described with reference to FIG. 3. In step S310, the information providing unit 112 provides channel information to the cognitive radio terminal 120.

In step S320, the cognitive radio terminal 120 receives the channel information provided from the information providing unit 112 to determine an operating channel using the received channel information.

In step S330, the cognitive radio terminal 120 collects quality information of the operating channel while using the determined operating channel.

In step S340, the cognitive radio terminal 120 transmits the collected channel quality information to the channel information providing database server 110.

In step S350, the receiving unit 114 receives the channel quality information and in step S360, the determining unit 116 uses the received channel quality information to determine the channel priority and update the channel information.

The information providing unit 112 provides the updated channel information including the channel priority determined in the determining unit 116 to the cognitive radio terminal 120.

These steps S310 to S360 are periodically or aperiodically repeated. That is, while the cognitive radio terminal 120 requests the channel information to the channel information providing database server 110 and uses the channel, the information may be repeatedly transmitted and received.

Specifically, when the information providing unit 112 provides the updated channel information including the channel priority determined in the determining unit 116 to the cognitive radio terminal 120, the cognitive radio terminal 120 uses the updated channel information to determine the operating channel and use the channel. If the cognitive radio terminal 120 collects channel quality information of the operating channel while using the operating channel determined using the updated channel information to transmit the channel quality information to the channel information providing database server 110, the receiving unit 114 receives the channel quality information and the determining unit 116 uses the quality information of the operating channel which is determined using the updated channel information received by the receiving unit 114 to determine the channel priority and reupdate the channel information.

The reupdated channel information is transmitted to the cognitive radio terminal 120 by the information providing unit 112 and the cognitive radio terminal 120 may redetermine the operating channel using the reupdated channel information. These processes may be periodically or aperiodically repeated.

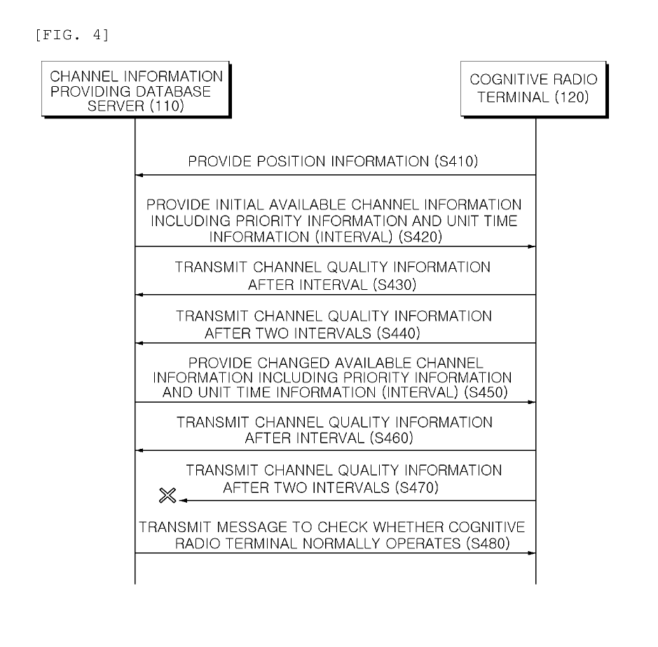

FIG. 4 is a flowchart illustrating a channel information providing method according to another exemplary embodiment of the present invention.

Referring to FIG. 4, in step S410, if the cognitive radio terminal 120 provides position information to the channel information providing database server 110 in order to request available channel information, in step S420, the information providing unit 112 transmits initial available channel information including the channel priority information and unit time information (interval) to the cognitive radio terminal 120.

Here, the unit time information (interval) may be a transmission period of the channel quality information which is transmitted from the cognitive radio terminal 120 to the channel information providing database server 110.

In step S430, the cognitive radio terminal 120 receives the initial available channel information and transmits the channel quality information collected after an interval time to the channel information providing database server 110.

In step S440, the cognitive radio terminal 120 transmits the collected channel quality information and transmits the channel quality information collected during an interval time after the interval time (that is, after a time corresponding to two intervals after receiving the initial available channel information) to the channel information providing database server 110.

In step S450, the receiving unit 114 receives the channel quality information transmitted at every interval and the determining unit 116 provides the changed available channel information including the priority information of the channel and the unit time information (Interval) using the received channel quality information. In this case, the unit time information to be provided may be changed. The changed available channel information is channel information updated by the determining unit 116.

In step S460, the cognitive radio terminal 120 receives the changed available channel information and transmits the channel quality information which is collected during the interval time when the interval time has elapsed after the interval time to the channel information providing database server 110.

After an interval time has elapsed after the cognitive radio terminal 120 transmits the channel quality information, in step S470, if the cognitive radio terminal 120 does not transmit the collected channel quality information or if the channel information providing database 110 does not receive the channel quality information during the elapsed interval in step S480, the channel information providing database server 110 transmits the message M1 checking whether the cognitive radio terminal 120 normally operates.

The channel information providing database server 110 may stop transmitting the channel information or continuously transmit the channel information or request transmission of the channel quality information in accordance with the response of the message M1 of the cognitive radio terminal 120. That is, if the response of the message M1 indicates that if the cognitive radio terminal 120 does not normally operate, the channel information providing database server 110 stops transmitting the channel information. If the cognitive radio terminal 120 normally operates, the channel information providing database server 110 requests the cognitive radio terminal 120 to transmit the channel quality information and continuously transmits the channel information.

The channel information providing method, the channel information providing database server 110, and the channel information providing system 100 according to the present invention promptly reallocate a better channel by reflecting a case when a quality of the channel allocated in the cognitive radio network system using a database server varies in accordance with the change in the time and the environment.

The channel information providing method, the channel information providing database server 110, and the channel information providing system 100 according to the present invention efficiently allocate the channel in the cognitive radio network system which provides the channel information based on the position information.

The channel information providing method, the channel information providing database server 110, and the channel information providing system 100 according to the present invention may obtain the condition change information of the allocated channel so that more efficient available channel information may be transmitted when subsequent available channel information (updated channel information) is transmitted and the available channel allocation for a plurality of requests may be efficiently performed.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A channel information providing method which uses a database server to provide channel information to a cognitive radio terminal based on position information, the method comprising:
providing channel information to at least one cognitive radio terminal;
receiving collected information regarding a quality of the channel from the at least one cognitive radio terminal; and
determining to update the channel information provided in the providing using the information received in the receiving.

2. The method of claim 1, wherein the providing provides the updated channel information to at least one of a cognitive radio terminal which provides the information collected for the channel quality or other cognitive radio terminal which requests to provide the channel information.

3. The method of claim 1, wherein the information received in the receiving is information which determines a priority of the channel in the database server.

4. The method of claim 1, wherein the information received in the receiving includes at least one of a signal to interference plus noise ratio (SINR), a noise energy level, a packet error rate (PER), a data rate, a channel utilization rate, and sensing signal information.

5. The method of claim 4, wherein the determining divides a channel in which there is no signal as a first priority group, a channel in which a signal is provided but coexists as a second priority group, and a channel which cannot be used as a third priority group using the received information on the quality of the channel,
determines the priority of the channel in the first priority group using the noise energy level and the packet error rate, and
determines the priority of the channel in the second priority group using the signal to interference plus noise ratio, the noise energy level, the data rate, the channel utilization rate, and the packet error rate.

6. The method of claim 1, wherein the receiving periodically receives the information collected for the quality of the channel from the cognitive radio terminal which receives channel information, and
if the information collected for the quality for the channel is not periodically received, transmits a message checking the operation to the cognitive radio terminal from which the information is not received.

7. The method of claim 1, wherein the updated channel information in the determining includes information which determines the priority of the channel by reflecting the information on the channel quality received in the receiving.

8. A database server which provides channel information to a cognitive radio terminal based on position information, the database server comprising:
an information providing unit which provides channel information to at least one cognitive radio terminal;
a receiving unit which receives information collected for a quality of the channel from the at least one cognitive radio terminal; and
a determining unit which uses the received collected information to update the provided channel information.

9. The database server of claim 8, wherein the information providing unit provides the updated channel information to at least one of a cognitive radio terminal which provides the information collected for the channel quality or other cognitive radio terminal which requests to provide the channel information.

10. The database server of claim 8, wherein the information received in the receiving unit is information which determines a priority of the channel.

11. The database server of claim 8, wherein the information received in the receiving unit includes at least one of a signal to interference plus noise ratio (SINR), a noise energy level, a packet error rate (PER), a data rate, a channel utilization rate, and a sensing signal.

12. The database server of claim 11, wherein the determining unit divides a channel in which there is no signal as a first priority group, a channel in which a signal is provided but coexists as a second priority group, and a channel which cannot be used as a third priority group using the received information on the quality of the channel,
determines the priority of the channel in the first priority group using the noise energy level and the packet error rate, and
determines the priority of the channel in the second priority group using the signal to interference plus noise ratio, the noise energy level, the data rate, the channel utilization rate, and the packet error rate.

13. The database server of claim 8, wherein the receiving unit periodically receives the information collected for the quality of the channel from the cognitive radio terminal which receives channel information, and
if the information collected for the quality for the channel is not periodically received, transmits a message checking the operation to the cognitive radio terminal from which the information is not received.

14. The database server of claim 8, wherein the updated channel information in the determining unit includes information which determines the priority of the channel by reflecting the information on the channel quality received in the receiving unit.

15. A channel information providing system which uses a database server to provide channel information to a cognitive radio terminal based on position information, the system comprising:
a channel information providing database device including: an information providing unit which provides channel information to at least one cognitive radio terminal; a receiving unit which receives information collected for a quality of the channel from the at least one cognitive radio terminal; and a determining unit which uses the received information received in the receiving unit to update the channel information provided in the information providing unit, and
a cognitive radio terminal which receives the provided channel information and collects and transmits information for the quality of the channel.

16. The system of claim 15, wherein the information providing unit provides the updated channel information to at least one of a cognitive radio terminal which provides the information collected for the channel quality or other cognitive radio terminal which requests to provide the channel information.

17. The system of claim 15, wherein the information received in the cognitive radio terminal includes at least one of a signal to interference plus noise ratio (SINR), a noise energy level, a packet error rate (PER), a data rate, a channel utilization rate, and a sensing signal.

18. The system of claim 15, wherein the updated channel information in the determining unit includes information which determines the priority of the channel by reflecting the information on the channel quality received in the receiving unit.

19. The system of claim 17, wherein the determining unit divides a channel in which there is no signal as a first priority group, a channel in which a signal is provided but coexists as a second priority group, and a channel which cannot be used as a third priority group using the received information of the quality of the channel,
determines the priority of the channel in the first priority group using the noise energy level and the packet error rate, and
determines the priority of the channel in the second priority group using the signal to interference plus noise ratio, the noise energy level, the data rate, the channel utilization rate, and the packet error rate.
